(19) United States
(12) Patent Application Publication
(10) Pub. No.: US 2017/0205745 A1
(43) Pub. Date: Jul. 20, 2017

(54) FIXING DEVICE AND IMAGE FORMING APPARATUS INCORPORATING SAME

(71) Applicants: Naoto Suzuki, Kanagawa (JP); Takashi Sakamaki, Kanagawa (JP)

(72) Inventors: Naoto Suzuki, Kanagawa (JP); Takashi Sakamaki, Kanagawa (JP)

(73) Assignee: Ricoh Company, Ltd., Tokyo (JP)

(21) Appl. No.: 15/384,211

(22) Filed: Dec. 19, 2016

(30) Foreign Application Priority Data
Jan. 15, 2016 (JP) 2016006334

(51) Int. Cl. G03G 15/20

(52) U.S. Cl. CPC G03G 15/2078

(57) ABSTRACT

A fixing device includes a fixing rotator, a heating rotator, an endless belt entrained around the fixing rotator and the heating rotator, and a pressure rotator to press against the fixing rotator via the endless belt. A first rotation transfer device is disposed on the heating rotator to transmit a torque of the heating rotator. A second rotation transfer device is disposed opposite the first rotation transfer device, and pressed against the first rotation transfer device by a biasing member. A rotation detector is disposed on a rotary shaft of the second rotation transfer device to detect rotation of the heating rotator. A pressure control mechanism moves the pressure rotator to and away from the endless belt to change a pressure force of the pressure rotator in response to detection of an increased or decreased rotational frequency of the heating rotator from a given rotational frequency by the rotation detector.

### CROSS-REFERENCE TO RELATED APPLICATION

This patent application is based on and claims priority pursuant to 35 U.S.C. §119(a) to Japanese Patent Application No. 2016-006334, filed on Jan. 15, 2016, in the Japan Patent Office, the entire disclosure of which is hereby incorporated by reference herein.

### BACKGROUND

Technical Field

Embodiments of the present disclosure generally relate to a fixing device and an image forming apparatus incorporating the fixing device, and more particularly, to a fixing device for fixing a toner image onto a recording medium and an image forming apparatus for forming an image on a recording medium, incorporating the fixing device.

Related Art

Various types of electrophotographic image forming apparatuses are known, including copiers, printers, facsimile machines, and multifunction machines having two or more of copying, printing, scanning, facsimile, plotter, and other capabilities. Such image forming apparatuses usually form an image on a recording medium according to image data. Specifically, in such image forming apparatuses, for example, a charger uniformly charges a surface of a photoconductor as an image bearer. An optical writer irradiates the surface of the photoconductor thus charged with a light beam to form an electrostatic latent image on the surface of the photoconductor according to the image data. A developing device supplies toner to the electrostatic latent image thus formed to render the electrostatic latent image visible as a toner image. The toner image is then transferred onto a recording medium either directly, or indirectly via an intermediate transfer belt. Finally, a fixing device applies heat and pressure to the recording medium bearing the toner image to fix the toner image onto the recording medium. Thus, the image is formed on the recording medium.

Such a fixing device typically includes a fixing rotator such as a roller, a belt, or a film, and an opposed rotator such as a roller or a belt pressed against the fixing rotator. The toner image is fixed onto the recording medium under heat and pressure while the recording medium is conveyed between the fixing rotator and the opposed rotator.

### SUMMARY

In one embodiment of the present disclosure, a novel fixing device is described that includes a fixing rotator, a heating rotator, an endless belt, a pressure rotator, a first rotation transfer device, a second rotation transfer device, a biasing member, a rotation detector, and a pressure control mechanism. The heating rotator heats the fixing rotator. The endless belt is entrained around the fixing rotator and the heating rotator to form a loop. The pressure rotator presses against the fixing rotator via the endless belt to form a fixing nip between the endless belt and the pressure rotator, through which a recording medium bearing a toner image is conveyed. The first rotation transfer device is disposed on an end portion of the heating rotator supporting the heating rotator to transmit a torque of the heating rotator. The second rotation transfer device is disposed opposite the first rotation transfer device and includes a rotary shaft. The biasing member presses the second rotation transfer device against the first rotation transfer device. The rotation detector is disposed on the rotary shaft of the second rotation transfer device to detect rotation of the heating rotator. The pressure control mechanism moves the pressure rotator to and away from the endless belt to change a pressure force of the pressure rotator in response to detection of an increased or decreased rotational frequency of the heating rotator from a given rotational frequency by the rotation detector.

Also described is a novel image forming apparatus that includes a photoconductor to bear a toner image and the fixing device described above.

### BRIEF DESCRIPTION OF THE DRAWINGS

A more complete appreciation of the disclosure and many of the attendant advantages thereof will be more readily obtained as the same becomes better understood by reference to the following detailed description of embodiments when considered in connection with the accompanying drawings, wherein:

FIG. 1 is a schematic sectional view of an image forming apparatus according to an embodiment of the present disclosure;

FIG. 2 is a cross-sectional view of a fixing device incorporated in the image forming apparatus of FIG. 1;

FIG. 3 is a graph illustrating a relationship between pressure exerted at a fixing nip and continuous sheet conveyance time period;

FIG. 4 is a perspective view of an inter-axial fastener incorporated in the fixing device of FIG. 2;

FIG. 5 is a perspective view of an example of a rotation detector incorporated in the fixing device of FIG. 2; and

FIG. 6 is a perspective view of another example of the rotation detector incorporated in the fixing device of FIG. 2.

The accompanying drawings are intended to depict embodiments of the present disclosure and should not be interpreted to limit the scope thereof. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and not all of the components or elements described in the embodiments of the present disclosure are indispensable to the present disclosure.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

As used herein, the singular forms “a”, “an”, and “the” are intended to include the plural forms as well, unless the context clearly indicates otherwise.

It is to be noted that, in the following description, suffixes Y, M, C, and K denote colors yellow, magenta, cyan, and black, respectively. To simplify the description, these suffixes are omitted unless necessary.

Referring now to the drawings, embodiments of the present disclosure are described below.

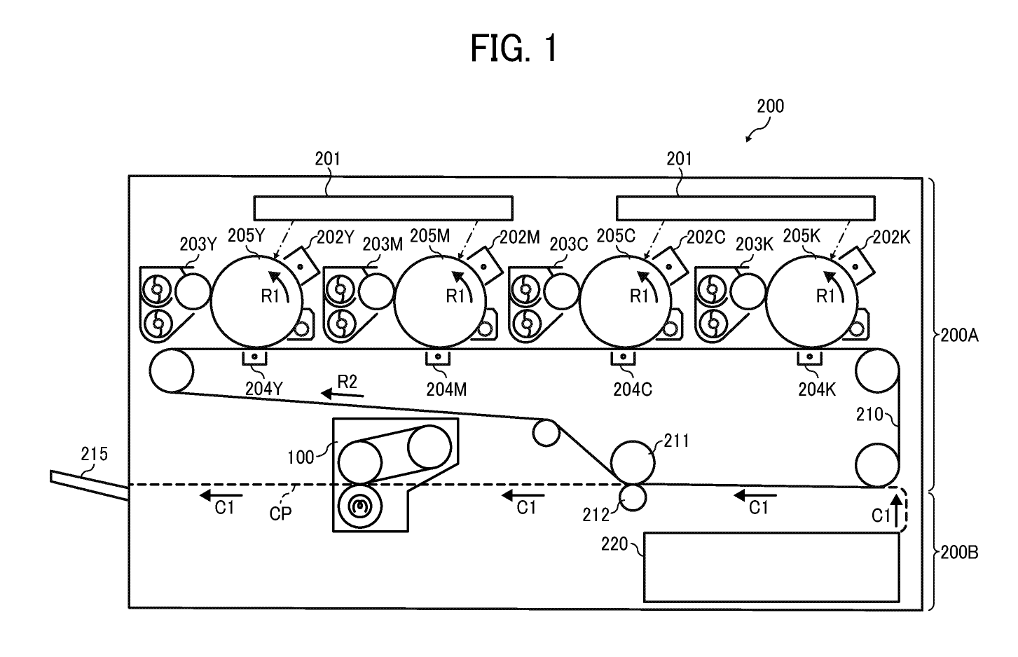

Initially with reference to FIG. 1, a description is given of a construction of an image forming apparatus 200 according to an embodiment of the present disclosure.

FIG. 1 is a schematic cross-sectional view of the image forming apparatus 200.

The image forming apparatus 200 is a tandem color photocopier that forms color and monochrome toner images on recording media by electrophotography. The image forming apparatus 200 is a high-speed machine that includes an image forming device 200A centrally located in a housing of the image forming apparatus 200, a sheet feeder 200B located below the image forming device 200A, and a scanner located above the image forming device 200A. In the image forming device 200A, the image forming apparatus 200 includes, e.g., a fixing device 100 and an intermediate transfer belt 210. The intermediate transfer belt 210 has a transfer face extending in a horizontal direction. On an outer circumferential surface of the intermediate transfer belt 210 are photoconductors 205Y, 205M, 205C, and 205K surrounded by various pieces of equipment to form images of colors having a complementary-color relationship with colors into which color data is separated. Specifically, the photoconductors 205Y, 205M, 205C, and 205K as image bearers that can respectively bear toner images of yellow, magenta, cyan, and black are arranged side by side along the transfer face of the intermediate transfer belt 210.

The photoconductors 205Y, 205M, 205C, and 205K are drum-shaped photoconductors rotatable in a counter-clockwise rotational direction R1 as illustrated in FIG. 1. The photoconductors 205Y, 205M, 205C, and 205K are surrounded by various pieces of equipment such as chargers 202Y, 202M, 202C, and 202K, developing devices 203Y, 203M, 203C, and 203K, primary transfer devices 204Y, 204M, 204C, and 204K, and cleaners, respectively. The developing devices 203Y, 203M, 203C, and 203K contain toner of yellow, magenta, cyan, and black, respectively. Optical writing devices 201 are disposed in an uppermost portion of the image forming device 200A.

The intermediate transfer belt 210 is entrained around drive and driven rollers and rotates in a clockwise rotational direction R2 as illustrated in FIG. 1. That is, the intermediate transfer belt 210 and the photoconductors 205Y, 205M, 205C, and 205K rotate in the same direction where the intermediate transfer belt 210 meets the photoconductors 205Y, 205M, 205C, and 205K. A secondary transfer roller 212 is disposed opposite a driven roller 211 that is one of the rollers around which the intermediate transfer belt 210 is entrained. A conveyance passage CP, defined by internal components of the image forming apparatus 200, is a passage for conveying a sheet P as a recording medium. As illustrated in FIG. 1, the conveyance passage CP is a lateral passage in a substantially horizontal direction between the secondary transfer roller 212 and the fixing device 100. The sheet feeder 200B includes a sheet tray 220 on which a plurality of sheets P rests, and a conveyance mechanism to pick up and convey the plurality of sheets P one by one to a secondary transfer position between the roller 211 and the secondary transfer roller 212 in a sheet conveyance direction C1.

To provide a fuller understanding of embodiments of the present disclosure, a description is now given of an image forming operation of the image forming apparatus 200 with continued reference to FIG. 1.

For example, the charger 202Y uniformly charges the surface of the photoconductor 205Y to form an electrostatic latent image thereon according to image data from the scanner. The developing device 203Y develops the electrostatic latent image with yellow toner, rendering the electrostatic latent image visible as a toner image of yellow. Thus, the toner image of yellow is formed on the surface of the photoconductor 205Y. The primary transfer device 204Y applied with a predetermined bias primarily transfers the toner image of yellow from the surface of the photoconductor 205Y onto the intermediate transfer belt 210.

Similarly, toner images of magenta, cyan, and black are formed on the photoconductors 205M, 205C, and 205K, respectively, and primarily transferred onto the intermediate transfer belt 210. Thus, the toner images of yellow, cyan, magenta, and black are primarily transferred onto the intermediate transfer belt 210 from the photoconductors 205Y, 205M, 205C, and 205K in sequence by static electricity while being superimposed one atop another to form a composite toner image on the intermediate transfer belt 210.

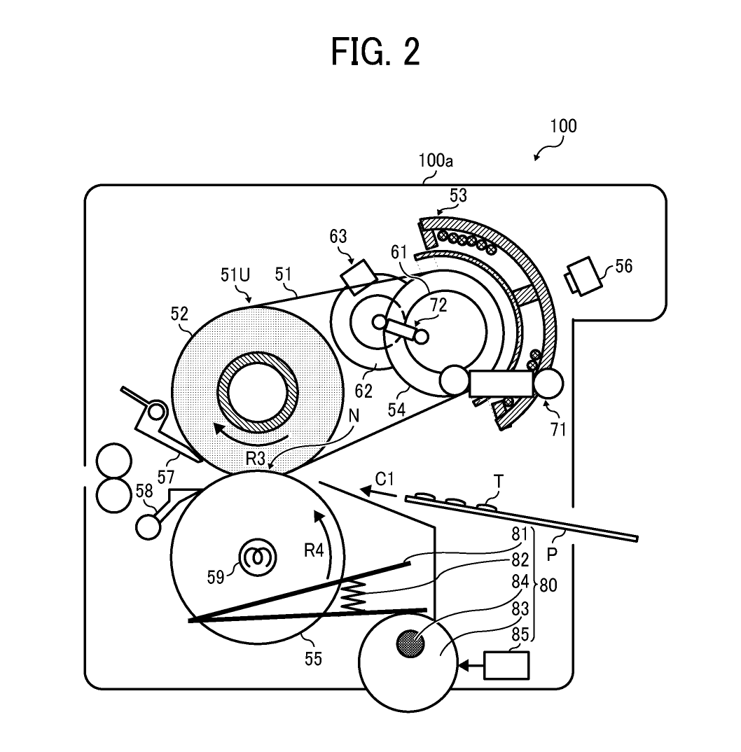

The toner image is secondary transferred onto the sheet P, which is conveyed from the sheet tray 220, at the secondary transfer position between the driven roller 211 and the secondary transfer roller 212. The sheet P bearing the toner image is conveyed to the fixing device 100 that includes, e.g., a fixing belt 51, a pressure roller 55, a fixing separator 57, and a pressure separator 58, which are illustrated in FIG. 2. In the fixing device 100, the toner image is fixed onto the sheet P while the sheet P is conveyed through an area of contact herein referred to as a fixing nip N, between the fixing belt 51 and the pressure roller 55. After the toner image is fixed onto the sheet P, the sheet P is ejected from the fixing nip N without wrapping around the fixing belt 51 or the pressure roller 55 as is guided by the fixing separator 57 and the pressure separator 58 disposed on an exit side of the fixing nip N, that is, downstream from the fixing nip N in the sheet conveyance direction C1. The sheet P bearing the fixed toner image is then conveyed to a stacker 215 along the sheet conveyance passage CP.

Referring now to FIG. 2, a description is given of the fixing device 100 incorporated in the image forming apparatus described above.

FIG. 2 is a cross-sectional view of the fixing device 100.

The fixing device 100 includes various components inside a fixing cover 100a. For example, the fixing device 100 includes the fixing belt 51, the pressure roller 55 as a pressure rotator, a fixing roller 52 as a fixing rotator rotatable in a clockwise rotational direction R3 as illustrated in FIG. 2, a heating roller 54 as a heating rotator, and a heating roller tension spring 71 as a biasing member secured to the heating roller 54 and a fixing frame. The heating roller tension spring 71 gives a given tension to the fixing belt 51, which is entrained around the fixing roller 52 and the heating roller 54 to form a loop. The pressure roller 55, disposed below the fixing belt 51, presses against the fixing belt 51 rotatably in a counter-clockwise rotational direction R4 as illustrated in FIG. 2. Specifically, the pressure roller 55 presses against the fixing roller 52 via the fixing belt 51 to form the fixing nip N between the fixing belt 51 and the pressure roller 55.

As described above, the fixing device 100 includes the fixing separator 57 and the pressure separator 58 disposed downstream from the fixing nip N in the sheet conveyance direction C1.

The heating roller tension spring 71 is mounted on each end portion of the heating roller 54 in a width direction, that is, an axial direction, of the heating roller 54.

The fixing belt 51 is an endless belt having a two-layer structure in cross section. Specifically, the fixing belt 51 is constructed of a base layer made of, e.g., polyimide and an elastic layer made of, e.g., silicone rubber. The fixing roller 52 is constructed of a metal tube and silicone rubber coating the metal tube. To shorten warm-up time, silicone rubber foam may be used that absorbs less heat from the fixing belt 51.

The heating roller 54 is a hollow roller made of stainless steel or a nickel alloy, and heated by a heater. In the present embodiment, the heater is an induction heater 53 that heats the heating roller 54 by electromagnetic induction. Alternatively, a halogen heater may be used as the heater that heats the heating roller 54.

The pressure roller 55 is a tubular roller that is typically constructed of a metal tube made of, e.g., aluminum or iron and an elastic layer made of, e.g., silicone rubber coating the metal tube.

The fixing belt 51 and the components disposed inside the loop formed by the fixing belt 51, that is, the fixing roller 52, the heating roller 54 and the like, constitute a belt unit 51U detachably coupled to the pressure roller 55.

As illustrated in FIG. 2, the fixing device 100 includes a pressure control mechanism 80, which includes a pressure lever 81, a pressure spring 82, a pressure cam 83, a pressure cam shaft 84, a drive motor, and a controller 85 that controls these devices. The pressure control mechanism 80 functions to selectively move the pressure roller 55 toward the fixing belt 51 to press the pressure roller 55 against the fixing belt 51, and move the pressure roller away from the fixing belt 51 to relieve pressure on the fixing belt 51.

When the fixing device 100 is actuated, for example, the fixing roller 52 is driven to rotate in the clockwise rotational direction R3 as illustrated in FIG. 2. As the fixing roller 52 rotates, the fixing belt 51 rotates clockwise together with the pressure roller 55 that is pressed against the fixing roller 52 via the fixing belt 51 and rotates in the counter-clockwise rotational direction R4 as illustrated in FIG. 2, to fix a toner image T onto the sheet P and eject the sheet P bearing the fixed toner image T from the fixing nip N. In the present embodiment, the fixing roller 52 is driven to rotate when the fixing device 100 is actuated. Alternatively, the fixing device 100 may be configured so that the pressure roller 55 is driven to rotate.

A fixing operation of the fixing device 100 starts with heating the heating roller 54. Specifically, the induction heater 53, disposed outside the heating roller 54, heats the heating roller 54 by electromagnetic induction. The heating roller 54 thus heated by the induction heater 53 heats the fixing belt 51. The induction heater 53 heats the heating roller 54 until the temperature of the fixing belt 51 detected by a thermopile 56 reaches a predetermined temperature (e.g., a temperature suitable for fixing the toner image T).

As illustrated in FIG. 2, a pressure heater 59 is disposed inside the pressure roller 55 to heat the pressure roller 55. Specifically, the pressure heater 59 generates heat to heat the pressure roller 55 to a predetermined temperature when a temperature increase is required, for example. In the present embodiment, as described above, the pressure roller 55 serves as a pressure rotator. Alternatively, the pressure rotator may be an endless belt entrained around two rollers.

In the fixing device 100, while the fixing belt 51 and the pressure roller 55 are rotated, an outer circumferential surface of the fixing belt 51 is heated to a predetermined temperature to fix the toner image T onto the sheet P at the fixing nip N. Specifically, the sheet P bearing the toner image T is conveyed in the sheet conveyance direction C1 through the fixing nip N where the fixing belt 51 and the pressure roller 55 press and heat the sheet P to melt toner contained in the toner image T, thereby fixing the toner image T onto the sheet P. The fixing separator 57 prevents sheet P bearing the fixing toner image T from wrapping around the fixing belt 51 when the sheet P is ejected from the fixing nip N. Similarly, the pressure separator 58 prevents sheet P bearing the fixing toner image T from wrapping around the pressure roller 55 when the sheet P is ejected from the fixing nip N. The sheet P thus ejected from the fixing nip N is conveyed in the sheet conveyance direction C1 along a conveyance guide.

In the fixing device 100, when the heating roller 54 is heated to a predetermined temperature and conveyance of the sheet P through the fixing device 100 is permitted, the sheet P is conveyed through the fixing nip N. If a print job includes continuous conveyance of the sheets P, the heating roller 54 is heated continuously to supplement heat which the sheets P absorb at the fixing nip N. The fixing belt 51 entrained around the fixing roller 52 and the heating roller 54 carries heat to the fixing nip N to fix the toner image T onto the sheet P while continuously providing heat to the fixing roller 52.

During continuous conveyance of the sheets P, the fixing roller 52 is continuously heated and thermally expanded, having an outer diameter increased from when conveyance of the sheets P is permitted. Accordingly, the thermal expansion of the fixing roller 52 increases pressure exerted at the fixing nip N together with a nip length of the fixing nip N in the sheet conveyance direction C1. The thermal expansion of the fixing roller 52 depends on the thermal expansion coefficient of silicone rubber as an elastic body. More specifically, the thermal expansion of the fixing roller 52 depends on a representative value 3.0×10 E−4/° C. of thermal expansion coefficient of silicone rubber. Accordingly, the amount of thermal expansion is substantially specified by a given heat amount per unit hour and a preset temperature.

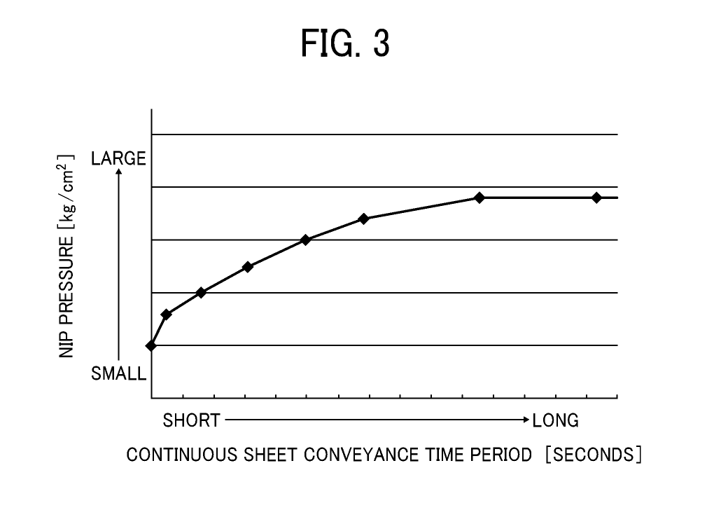

Referring now to FIG. 3, a description is given of a relationship between pressure exerted at the fixing nip N and continuous conveyance time period of the sheets P conveyed through the fixing device 100.

FIG. 3 is a graph illustrating the relationship between the pressure exerted at the fixing nip N and the continuous conveyance time period of the sheets P conveyed through the fixing device 100.

The temperature of the heating roller 54 and the pressure exerted at the fixing nip N are preset taking into consideration the fixability of toner onto the sheet P. If the sheet P is constructed of a plurality of overlapping sheets such as an envelope, the sensitivity of the pressure exerted at the fixing nip N is relatively high. If pressure other than a predetermined pressure is exerted at the fixing nip N, the overlapping sheets may deviate from each other in the sheet conveyance direction C1 and cause wrinkles on the sheet P.

Relatedly, when a drive motor that rotates a roller of the fixing device 100 maintains a constant rotational frequency, changes in the outer diameter of the fixing roller 52 due to thermal expansion increase a surface linear velocity of the fixing roller 52, further increasing the rotational linear velocity of the fixing belt 51 and the rotational frequency of the heating roller 54.

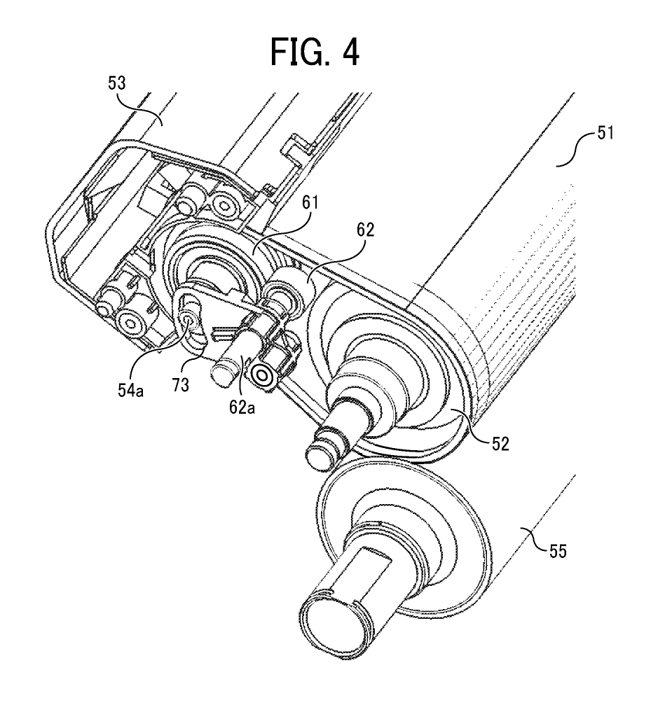

Referring back to FIG. 2, a first rotation transfer device 61 is mounted on an end portion of the heating roller 54 in the axial direction thereof. The first rotation transfer device 61 is, e.g., a gear that is shaped to support the heating roller 54 and transfers a torque of the heating roller 54 to an end face. A second rotation transfer device 62 is disposed opposite the first rotation transfer device 61. The second rotation transfer device 62 is, e.g., a gear that meshes with the first rotation transfer device 61. A biasing member 72, such as a tension coil spring, presses the second rotation transfer device 62 against the first rotation transfer device 61. A rotation detector 63 is disposed on a rotary shaft 62a, as specifically illustrated in FIG. 4, for example, of the second rotation transfer device 62. The rotation detector 63 detects rotational states of the heating roller 54 and the fixing belt 51.

With the structure described above, changes in the pressure exerted at the fixing nip N due to thermal expansion of the fixing roller 52 can be perceived as changes in the rotational frequency of the heating roller 54. Depending on the rotational frequency of the heating roller 54 detected by the rotation detector 63, the pressure control mechanism 80 adjusts the position of the pressure cam 83, more specifically, the rotational angle of the pressure cam 83, with the drive motor, so as to exert predetermined pressure at the fixing nip N during continuous conveyance of, e.g., envelope-shaped sheets P. Thus, the pressure is exerted at the fixing nip N under control, preventing wrinkles on the envelope-shaped sheets P continuously conveyed.

For example, when the rotation detector 63 detects changes in the rotational frequency of the heating roller 54, such as an increased or decreased rotational frequency of the heating roller 54 from a given rotational frequency, the pressure control mechanism 80 continuously changes a pressure force of the pressure roller 55. Thus, in the present embodiment, the pressure exerted at the fixing nip N formed between the fixing roller 52 as a fixing rotator and the pressure roller 55 as a pressure rotator is controlled, together with the nip length of the fixing nip N, to be optimum for fixing a toner image on the envelope-shaped sheet P as a recording medium even when the fixing roller 52 is thermally expanded.

Referring now to FIG. 4, a description is given of an inter-axial fastener 73 incorporated in the fixing device 100.

FIG. 4 is a perspective view of the inter-axial fastener 73.

The inter-axial fastener 73 couples a metal tube 54a of the heating roller 54 to the rotary shaft 62a of the second rotation transfer device 62 while maintaining a given inter-axial distance therebetween. The metal tube 54a of the heating roller 54 and the first rotation transfer device 61 have a common axis. Since the inter-axial distance between the metal tube 54a of the heating roller 54 and the rotary shaft 62a of the second rotation transfer device 62 is regulated, the first rotation transfer device 61 mounted on the end portion of the heating roller 54 reliably transmits rotation to the second rotation transfer device 62. Accordingly, even if the heating roller 54 stretching the fixing belt 51 oscillates due to thermal expansion of the fixing roller 52 and causes a defective rotation of the fixing belt 51, such a defective rotation of the fixing belt 51 is accurately detected as described below.

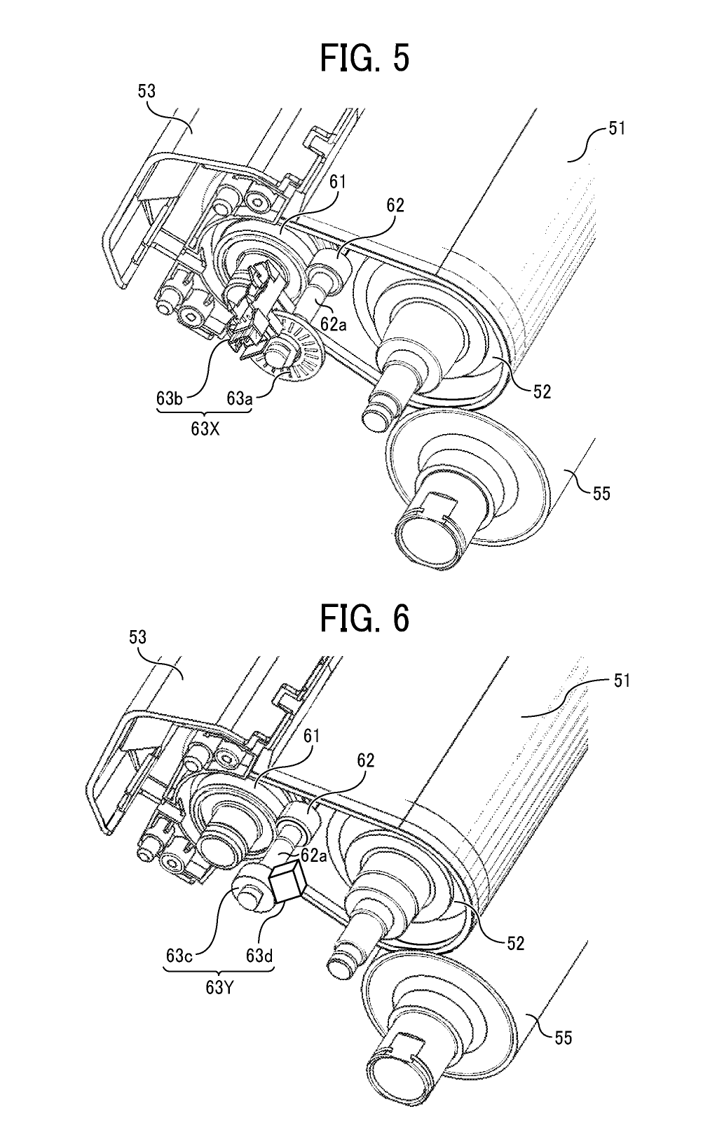

Referring now to FIG. 5, a description is given of an example of the rotation detector 63 incorporated in the fixing device 100.

FIG. 5 is a perspective view of a rotation detector 63X.

The rotation detector 63X includes a photosensor 63b and a slit encoder 63a disposed on the rotary shaft 62a of the second rotation transfer device 62. Thus, the rotation detector 63X is configured to accurately detect defective rotation of the heating roller 54 and the fixing belt 51.

Referring now to FIG. 6, a description is given of another example of the rotation detector 63 incorporated in the fixing device 100.

FIG. 6 is a perspective view of a rotation detector 63Y.

The rotation detector 63Y includes a magnetic sensor 63d and a magnetic encoder 63c disposed on the rotary shaft 62a of the second rotation transfer device 62. The magnetic encoder 63c is smaller than the slit encoder 63a. Similarly, the magnetic sensor 63d as a reader is smaller than the photosensor 63b. Thus, the rotation detector 63Y reduces the space for layout of internal components such as a sensor, allowing the fixing device 100 to be downsized.

Since the second rotation transfer device 62 is separated from the fixing belt 51 inside the loop formed by the fixing belt 51 entrained around the fixing roller 52 and the heating roller 54, an end portion of the fixing belt 51 does not come into contact the second rotation transfer device 62 even if the fixing belt 51 meanders, allowing the fixing device 100 to be downsized in a width direction, that is, an axial direction of the fixing belt 51.

Embodiments of the present disclosure are not limited to the embodiments and examples described above. The image forming apparatus 200 may be configured as desired. For example, the photoconductors 205 may be aligned in an order different from the order illustrated in FIG. 1. In the embodiment described above, the image forming apparatus 200 has a tandem structure. Alternatively, the image forming apparatus 200 may have another structure. For example, a plurality of developing devices may be disposed around one photoconductor, or a revolver developing device may be used. The image forming apparatus 200 may be a full-color machine employing toner of three colors, a multicolor machine employing toner of two colors, or a monochrome machine that forms a monochrome image. The image forming apparatus 200 is not limited to a copier. Alternatively, the image forming apparatus 200 may be a printer, a facsimile machine, or a multifunction peripheral (MFP) having at least one of copying, printing, scanning, facsimile, and plotter functions.

As described above, in a fixing device including an endless belt entrained around a fixing roller and a heating roller, a drive roller (e.g., heating roller, fixing roller, or pressure roller) is driven to rotate at a given rotational frequency. However, when the fixing roller is thermally expanded and has an outer diameter increased, the surface linear velocity of the fixing roller increases, thereby increasing the rotational linear velocity of the endless belt and the rotational frequency of the heating roller. During continuous conveyance of recording media, the fixing roller is continuously heated even after reaching a predetermined temperature and thermally expanded, increasing pressure exerted at a fixing nip formed between the endless belt and the pressure roller, together with a nip length of the fixing nip in a recording medium conveyance direction. To address such a circumstance, according to an embodiment of the present disclosure, a rotational state of the heating roller is detected to exert optimum pressure at the fixing nip, producing an optimum nip length of the fixing nip, for fixing a toner image on an envelope as a recording medium at the fixing nip even when the fixing roller is thermally expanded.

Specifically, in a fixing device (e.g., fixing device 100) according to an embodiment of the present disclosure, a first rotation transfer device (e.g., first rotation transfer device 61) is disposed on an end portion of a heating rotator (e.g., heating roller 54) supporting the heating rotator to transmit a torque of the heating rotator. A second rotation transfer device (e.g., second rotation transfer device 62) is disposed opposite the first rotation transfer device and provided with a biasing member (e.g., biasing member 72) and a rotation detector (e.g., rotation detector 63). The biasing member presses the second rotation transfer device against the first rotation transfer device. The rotation detector is disposed on a rotary shaft (e.g., rotary shaft 62a) of the second rotation transfer device to detect rotation of the heating rotator. A pressure control mechanism (e.g., pressure control mechanism 80) moves a pressure rotator (e.g., pressure roller 55) to and away from an endless belt (e.g., fixing belt 51) to change a pressure force of the pressure rotator when the rotation detector detects an increased or decreased rotational frequency of the heating rotator from a given rotational frequency. In short, the fixing device includes the first rotation transfer device, the second rotation transfer device, and the rotation detector to detect a rotational speed of the heating rotator, and the pressure control mechanism to control the pressure force of the pressure rotator based on a relationship between pressure exerted at a fixing nip (e.g., fixing nip N) and the rotational speed of the heating rotator changed by thermal expansion of a fixing rotator (e.g., fixing roller 52). Accordingly, the pressure exerted at the fixing nip is controlled.

In the fixing device, an inter-axial fastener (e.g., inter-axial fastener 73) couples the heating rotator to the second rotation transfer device while maintaining a given inter-axial distance between the heating rotator and the second rotation transfer device. The heating rotator and the first rotation transfer device have a common axis. The rotation detector detects rotation of the rotary shaft of the second rotation transfer device. Accordingly, the rotational speed of the heating rotator is reliably detected. The pressure control mechanism controls the pressure force of the pressure rotator based on the rotational speed of the heating rotator thus detected. Accordingly, the pressure exerted at the fixing nip is controlled.

The heating rotator is in contact with the endless belt because of a biasing member (e.g., heating roller tension spring 71) disposed on each end portion of the heating rotator in an axial direction thereof to stretch the endless belt. Accordingly, the rotation detector that detects rotation of the heating rotator is configured to detect rotation of the endless belt and damage to the endless belt.

The rotation detector includes, e.g., a slit encoder (e.g., slit encoder 63a) and a photosensor (e.g., photosensor 63b) to accurately detect the rotational speed of the heating rotator.

Alternatively, the rotation detector may include a magnetic encoder (e.g., magnetic encoder 63c) and a magnetic sensor (e.g., magnetic sensor 63d). In this case, the rotation detector is smaller than the rotation detector described above, downsizing the fixing device.

The second rotation transfer device is disposed inside a loop formed by the endless belt to accurately detect rotational speed regardless of meandering of the endless belt and to downsize the fixing device.

An image forming apparatus (e.g., image forming apparatus 200) incorporating the fixing device described above is a reliable image forming apparatus that accurately detects rotation of the heating rotator and the endless belt of the fixing device.

The present disclosure has been described above with reference to specific embodiments. It is to be noted that the present disclosure is not limited to the details of the embodiments described above, but various modifications and enhancements are possible without departing from the scope of the present disclosure. It is therefore to be understood that the present disclosure may be practiced otherwise than as specifically described herein. For example, elements and/or features of different embodiments may be combined with each other and/or substituted for each other within the scope of the present disclosure. The number of constituent elements and their locations, shapes, and so forth are not limited to any of the structure for performing the methodology illustrated in the drawings.

What is claimed is:

1. A fixing device comprising:
a fixing rotator;
a heating rotator to heat the fixing rotator;
an endless belt entrained around the fixing rotator and the heating rotator to form a loop;
a pressure rotator to press against the fixing rotator via the endless belt to form a fixing nip between the endless belt and the pressure rotator, through which a recording medium bearing a toner image is conveyed;
a first rotation transfer device disposed on an end portion of the heating rotator in an axial direction of the heating rotator supporting the heating rotator to transmit a torque of the heating rotator;
a second rotation transfer device disposed opposite the first rotation transfer device, the second rotation transfer device including a rotary shaft;
a biasing member to press the second rotation transfer device against the first rotation transfer device;
a rotation detector disposed on the rotary shaft of the second rotation transfer device to detect rotation of the heating rotator; and
a pressure control mechanism to move the pressure rotator to and away from the endless belt to change a pressure force of the pressure rotator in response to detection of an increased or decreased rotational frequency of the heating rotator from a given rotational frequency by the rotation detector.

2. The fixing device according to claim 1, further comprising an inter-axial fastener to couple the heating rotator to the second rotation transfer device while maintaining a given inter-axial distance between the heating rotator and the second rotation transfer device,
wherein the heating rotator and the first rotation transfer device have a common axis, and
wherein the rotation detector detects rotation of the rotary shaft of the second rotation transfer device.

3. The fixing device according to claim 1, further comprising another biasing member disposed on the end portion of the heating rotator in the axial direction of the heating rotator to stretch the endless belt.

4. The fixing device according to claim 1, wherein the rotation detector includes a slit encoder and a photosensor.

5. The fixing device according to claim 1, wherein the rotation detector includes a magnetic encoder and a magnetic sensor.

6. The fixing device according to claim 1, wherein the second rotation transfer device is disposed inside the loop formed by the endless belt.

7. An image forming apparatus comprising:
a photoconductor to bear a toner image; and
the fixing device according to claim 1.
